(19) United States
(12) Patent Application Publication
(10) Pub. No.: US 2025/0362142 A1
(43) Pub. Date: Nov. 27, 2025

(54) INFORMATION PROVISION METHOD AND INFORMATION PROVISION DEVICE

(71) Applicant: Nissan Motor Co., Ltd., Kanagawa (JP)

(72) Inventor: Toru Oizumi, Kanagawa-ku (JP)

(73) Assignee: Nissan Motor Co., Ltd., Kanagawa (JP)

(21) Appl. No.: 18/873,885

(22) PCT Filed: May 13, 2022
(86) PCT No.: PCT/JP2023/020334

§ 371 Date: Dec. 11, 2024

(30) Foreign Application Priority Data
Jun. 13, 2022 (JP) 2022-095063

(51) Int. Cl. G01C 21/34

(52) U.S. Cl. CPC G01C 21/3476; G01C 21/3484

(57) ABSTRACT

An attribute of a user is acquired; a current location of the user is acquired after the user has started traveling; when a POI is present within a predetermined range from the current location of the user on a standard map including POIs to which attributes have been assigned, it is determined whether or not an attribute of a target POI within the predetermined range matches the attribute of the user; and when determining that the attribute of the target POI matches the attribute of the user, a control command to suggest the target POI as a destination is transmitted.

### TECHNICAL FIELD

The present invention relates to an information provision method and an information provision device.

This application claims priority based on Japanese Patent Application No. 2022-095063, filed on Jun. 13, 2022, and for designated countries that allow incorporation by reference to literature, the contents described in the above-described application are incorporated herein by reference and made a part of the description of this application.

### BACKGROUND ART

There is known a technology of receiving starting point information and destination information, determining a spot that is close enough to a starting point or a destination to satisfy a predetermined location condition and has a user-specific dynamic attractiveness high enough to satisfy a predetermined attractiveness condition, and outputting spot-related information regarding the determined spot (Patent Document 1).

### PRIOR ART DOCUMENT

### Patent Document

Patent Document 1: Japanese Unexamined Patent Application Publication No. 2016-148881

### SUMMARY OF INVENTION

### Problems to Be Solved by Invention

However, since the technology of Patent Document 1 is a technology that suggests a spot around a route to the destination at the time when the route is searched for, there is a problem that it cannot suggest a spot suitable for a user according to the actual location of the user during traveling, for example, when the user strays from the route after the user has started traveling.

A problem to be solved by the present invention is to provide an information provision method and an information provision device that can suggest a spot suitable for a user according to the actual location of the user during traveling after the user has started traveling.

### Means for Solving Problems

The present invention solves the above problem by: acquiring an attribute of a user; acquiring a current location of the user after the user has started traveling; when a POI is present within a predetermined range from the current location of the user on a standard map including POIs to which attributes have been assigned, determining whether or not an attribute of a target POI within the predetermined range matches the attribute of the user; and when it is determined that the attribute of the target POI matches the attribute of the user, transmitting a control command to suggest the target POI as a destination.

### Effects of Invention

According to the present invention, it is possible to suggest a spot suitable for the user according to the actual location of the user during traveling after the user has started traveling.

### BRIEF DESCRIPTION OF DRAWINGS

FIG. 1 is a block diagram of an information provision system according to a first embodiment of the present invention.

FIG. 2A is a diagram illustrating an example of a screen on which a target POI is displayed on a standard map in the present invention.

FIG. 2B is a diagram illustrating an example of a screen on which a target POI is displayed on a specialized map in the present invention.

FIG. 3 is a flowchart illustrating an example of a control procedure for performing an information provision method according to the first embodiment.

FIG. 4 is a time chart before the start of route guidance to a target POI in the information provision system according to the first embodiment.

FIG. 5 is a block diagram of an information provision system according to a second embodiment of the present invention.

### MODES(S) FOR CARRYING OUT THE INVENTION

### First Embodiment

An embodiment of the present invention will be described below with reference to the drawings. In the present embodiment, an information provision method and an information provision device according to the present invention will be described by way of example in which they are applied to an information provision system.

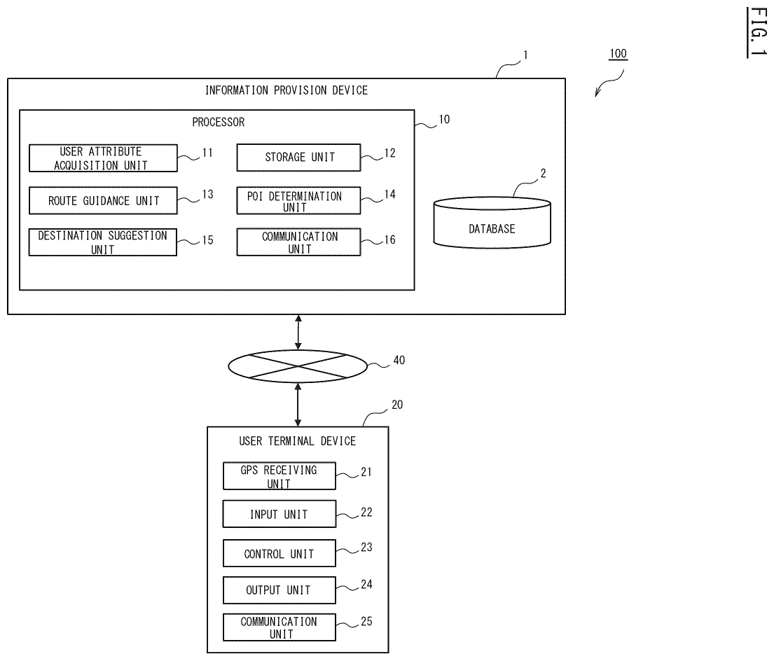

FIG. 1 is a block diagram of an information provision system 100 including an information provision device 1 according to the present embodiment. As illustrated in FIG. 1, the information provision system 100 includes the information provision device 1 and a user terminal device 20. The information provision device 1 and the user terminal device 20 are configured to be able to exchange information with each other via a communication network 40. Examples of the communication network 40 include a mobile phone network, a wireless LAN network, a DSRC network, and a power line communication network.

In the information provision system 100, the information provision device 1 provides information to a user through the user terminal device 20. The information to be provided to the user includes, for example, a map, a route from the current location of the user to the destination, and spot information on POIs. The user terminal device 20 is a device carried by the user. In the present embodiment, the user travels to the destination by a means of travel, such as a car, a bicycle, walking, and public transportation, following route guidance output from the user terminal device 20. Although one user terminal device 20 is illustrated in the information provision system 100 illustrated in FIG. 1, the information provision system 100 may be configured to include a plurality of user terminal devices 20.

The information provision device 1 includes a database 2 and a processor 10. The database 2 includes a plurality of different types of map data. The map data includes standard maps and specialized maps. The standard map is a map that includes at least information necessary for the user to travel. For example, for the user traveling by vehicle, the standard map includes at least information necessary to drive the vehicle. The standard map includes at least road information. The road information may include the type of road (e.g., a general road, a toll road, etc.) and the locations of intersections, stop lines, traffic lights, and road signs.

The standard map may be a record of POIs to which attributes have been assigned. The attribute of a POI indicates a field to which the POI belongs. For example, the attribute is an academic-related field or a hobby-related field. The academic-related field includes, for example, history-, geography-, geology-, meteorology-, and paleontology-related fields. The academic-related field needs to include at least any one of these fields, and may include one field or a plurality of fields. Further, the hobby-related field includes, for example, restaurant-, shrine-and-temple-, and mountain-climbing-related fields. The hobby-related field needs to include at least any one of these fields, and may include one field or a plurality of fields. In the present embodiment, for each of the POIs, a field to which the POI belongs is set in advance as an attribute of the POI. For example, when a POI is a historical building, the POI is classified as the field of “History”, and the attribute of the POI is set to “History”. The attribute of a POI may also include a main field and a sub-field linked to the main field. For example, “History” is set as the main field, and “Events”, “Historical Sites”, and “Politics” are set as sub-fields of “History”.

A POI may also have a plurality of attributes. A POI may also have an attribute score that is a numerical value representing the degree to which the POI is recommended to users who prefer a field to which the POI belongs. When the attribute of a POI is “History”, the POI's attribute score indicates the degree to which the POI is recommended to users who prefer “History”. For example, the POI's attribute score is represented as a five-level score. The attribute score may be determined using a score from word-of-mouth reviews on the Internet, or may be set based on the past behavior histories of other users. For example, when users with a particular attribute visit a POI frequently, the attribute of the POI is set according to the attribute of the users who visit the POI frequently, and the POI's attribute score is set high. Further, the POI's attribute score may be a binary value indicating whether or not the POI is recommended. In the present embodiment, the standard map includes spot information including the locations and names of POIs, but does not include detailed information on specific spots, such as POIs, or information specialized in a specific field.

The specialized map is a map specializing in information on a specific field. The specialized map is a map that is different from the standard maps, and is also a map providing more detailed information on a specific field than the standard maps. The standard map is a map used for users traveling, whereas the specialized map is a map used for users learning. Examples of the specialized map include an old map, a map of old country names, a topographical map, a contour map, a weather map, and a hazard map. The database 2 stores, for each specific field, a map specializing in information on the specific field. In other words, the database 2 stores, for each attribute, a specialized map associated with the attribute.

In the present embodiment, the specialized map is presented for a user who wishes to improve their expertise in a specific field. For example, the specialized maps include maps specializing in information on academic-related fields. If the user prefers history, an old map and a map of old country names are presented. If the user prefers geology, a topographical map and a contour map are presented. If the user prefers meteorology, a weather map and a hazard map are presented. In the present embodiment, as described below, a field that the user prefers is obtained as an attribute of the user, and a specialized map suitable for the attribute of the user is displayed, thereby allowing the user to learn the field in which the user is interested.

The specialized maps may include maps specializing in information on hobby-related fields. For example, if the user prefers going around restaurants, a restaurant map specializing in information on restaurants is presented. If the user prefers making a tour of shrines and temples, a map specializing in information on shrines and temples is presented. If the user prefers mountain climbing, a map specializing in information on mountain climbing, for example, a hiking map, is presented.

The processor 10 includes a computer having hardware and software, and this computer includes a ROM that stores a program, a CPU that executes the program stored in the ROM, and a RAM that functions as an accessible storage device. Note that operable circuits to be used include, instead of or together with the CPU, an MPU, a DSP, an ASIC, an FPGA, and the like. As illustrated in FIG. 1, the processor 10 is configured to include, as functional blocks, a user attribute acquisition unit 11, a storage unit 12, a route guidance unit 13, a POI determination unit 14, a destination suggestion unit 15, and a communication unit 16, and implements their respective functions through cooperation between software and hardware for performing the respective processes. Note that, in the present embodiment, the functions of the processor 10 are divided into six blocks, and the functions of each functional block are described. However, the functions of the processor 10 do not necessarily have to be divided into six blocks.

The user attribute acquisition unit 11 acquires the attribute of the user from the user terminal device 20. For example, the user attribute acquisition unit 11 acquires a field that the user prefers as an attribute of the user. The attribute of the user is a field in which the user is interested among a plurality of fields classified in advance. The attribute of the user may be preselected by the user or may be pre-estimated. For example, if the user prefers the field of “History”, the attribute of the user is “History”. The user may have a plurality of attributes. For example, the user attribute acquisition unit 11 acquires, as an attribute of the user, a field selected by the user as a preferred field in a questionnaire. The user attribute acquisition unit 11 may also acquire an attribute score which is a numerical value representing the degree to which the user prefers a specific field. For example, the user attribute acquisition unit 11 acquires, as an attribute score, evaluation points for each field selected by the user in a questionnaire on a five-level evaluation scale. When the user selects 5 points for “History” and 3 points for “Geology” in a questionnaire, the user's attribute score for “History” is 5 points, and the user's attribute score for “Geology” is 3 points. The attribute score for a specific field may also be indicated by a binary value of “like” or “dislike” for each field.

The user attribute acquisition unit 11 may also estimate the attribute of the user from the behavior history of the user. For example, the user attribute acquisition unit 11 acquires the behavior history of the user, identifies a POI that the user has visited, and identifies a field to which the POI belongs. The user attribute acquisition unit 11 estimates a higher user's attribute score for a specific field as the user visits a POI belonging to the specific field more frequently. Further, the attribute of the user may be dynamically changed. For example, the user attribute acquisition unit 11 may acquire the behavior history of the user at regular intervals, and update the attribute of the user based on the acquired behavior history of the user. Further, when the user is a child, the attribute of the user may be a field selected by their parent in which the parent would like the child to get interested as part of education of the child.

Further, in the present embodiment, the attributes of POIs are not limited to academic- or hobby-related fields, and may be classified as other categories. For example, the attribute of a POI is shopping, restaurants, supermarkets, or gas stations. For example, the attribute of a POI may also include subcategories into which each category is subdivided. When the category is restaurants, the subcategories are Japanese cuisine, Chinese cuisine, Italian cuisine, French cuisine, and the like. In this case, the user attribute acquisition unit 11 estimates a high attribute score for the category of POIs that the user frequently visits, based on the behavior history of the user.

The storage unit 12 acquires various types of maps from outside the information provision device 1, and stores the various types of maps in the database 2. The storage unit 12 acquires a standard map from an external database, and stores the standard map in the database 2. For example, the storage unit 12 may acquire information on standard maps and POIs, record the POIs on the acquired standard maps, and store the standard maps including the POIs in the database 2. The storage unit 12 updates the attributes and attribute scores of the POIs stored in the database 2 at regular intervals. The storage unit 12 also acquires specialized maps from an external database, and stores the specialized maps in the database 2.

The route guidance unit 13 provides route guidance to the user through the user terminal device 20 along a travel route from the current location of the user to the destination. When the route guidance unit 13 acquires the destination of the user and the current location of the user from the user terminal device 20, the route guidance unit 13 refers to the standard map and generates a travel route from the current location of the user to the destination. The route guidance unit 13 uses location information of the user terminal device 20 received by a GPS receiving unit 21 as the current location of the user. The route guidance unit 13 also uses destination information input by the user through an input unit 22 as the destination of the user. The travel route may be a route that passes through a plurality of destinations. The route guidance unit 13 transmits to the user terminal device 20 a control command to display the travel route on the standard map. Specifically, in the present embodiment, the route guiding unit 13 transmits to the user terminal device 20 a control command to display the standard map before the user starts traveling.

The POI determination unit 14 searches for POIs located within a predetermined range from a predetermined point, and determines whether or not the attribute of a found target POI matches the attribute of the user. First, the POI determination unit 14 sets a predetermined point serving as the center of a search range. The predetermined point is, for example, the current location of the user. The predetermined point may also be a search center point set by the user on a standard map.

When the predetermined point is set to the current location of the user, the POI determination unit 14 searches for POIs within a first predetermined range from the current location of the user. The first predetermined range is a search range for POIs, and is, for example, a circular range having a radius of a predetermined distance, in which the current location of the user is centered. The predetermined distance may be different depending on a means of travel for the user (a car, a bicycle, walking, etc.). Further, the first predetermined range may be a range that the user can travel from the current location within a predetermined time. Further, the first predetermined range is not limited to the circular range in which the current location of the user is centered, and may be a range within a predetermined distance from the travel route from the current location of the user to the destination, or a range that the user can travel within a predetermined time after leaving the travel route. When the means of travel is public transportation, such as a train and a bus, the first predetermined range may also be a circular range in which a point where the user can get off, such as a station or a stop, is centered.

In the present embodiment, after the travel route has been displayed and the user has started traveling along the travel route to the destination, the POI determination unit 14 acquires the current location of the user at regular intervals, and searches for POIs within the first predetermined range in which the current location of the user is centered. For example, the POI determination unit 14 determines, based on the current location of the user and a standard map including POIs, whether or not a POI is present within the first predetermined range from the current location of the user on the standard map.

Note that, when the user sets a search center point on the standard map before or while the user travels, the POI determination unit 14 may determine whether or not a POI is present within a second predetermined range from the search center point on the standard map. The second predetermined range is a range that is set in a similar manner to the first predetermined range. The description of the first predetermined range will be used for the explanation of the second predetermined range as appropriate.

When the POI determination unit 14 determines that a POI is present within the first predetermined range, the destination suggestion unit 15 acquires the attribute of a target POI within the first predetermined range from the standard map, and determines whether or not the attribute of the target POI matches the attribute of the user. Specifically, the destination suggestion unit 15 checks whether or not a field to which the target POI belongs matches a preferred field of the user.

For example, the destination suggestion unit 15 calculates the degree of a match between the attribute of the target POI and the attribute of the user, and when the degree of the match is higher than a predetermined threshold, determines that the attribute of the target POI matches the attribute of the user. The destination suggestion unit 15 calculates a higher degree of the match as the user's attribute score and the target POI's attribute score are higher. The degree of the match is calculated, for example, by multiplying the user's attribute score by the target POI's attribute score. The degree of the match may also be calculated using an increasing function with the user's attribute score and the target POI's attribute score as parameters.

When it is determined that the attribute of the target POI matches the attribute of the user, the destination suggestion unit 15 transmits a control command to suggest the target POI as a destination to the user terminal device 20. The control command to suggest the target POI as a destination is a control command to suggest changing the destination to the target POI, or a control command to suggest setting the target POI as a waypoint between the current location of the user and the destination. For example, the destination suggestion unit 15 transmits to the user terminal device 20 a control command to display spot information of the target POI and suggestion information that suggests the target POI as a destination. The spot information of the target POI includes the location of the target POI, the spot name of the target POI, and the attribute of the target POI. The spot information may include detailed information on a field to which the target POI belongs. For example, if the attribute of the target POI is “History”, the detailed information is information about the history of the target POI, such as the year the building of the target POI was constructed. The detailed information may also include spot information of another POI that has the same attribute as the target POI among other POIs around the target POI. Note that the spot information and the suggestion information may be output as voice information.

The spot information of a POI includes, for example, topographical information, historical information, and meteorological information. The topographical information includes volcanoes, plateaus, terraces, alluvial fans, deltas, basins, ria coasts, plains, mountains, mountain ranges, rivers, limestone caves, wind caves, ice caves, seas of trees, faults, Fossa Magna, ring levees, watersheds, mountain ridges and mountain names, and other topographically distinctive places. The historical information includes historic sites, ancient battlefields, shrines and temples, transportation routes of the Edo period (the Tokaido, the Nakasendo, etc.), old administrative divisions (Sagami Province, Suruga Province, etc.), and other places where historical events occurred. The meteorological information includes places where rain, snow, hail, sudden downpours, tornadoes, lightning, and the like are occurring, as well as disaster alert zones.

For example, when the attribute of the user is “Geology” and mountains are present within the first predetermined range from the current location of the user, the destination suggestion unit 15 determines that the attribute of the mountains matches the attribute of the user in “Geology”, and notifies the user of the location, name, and attribute of the mountains through the user terminal device 20. For example, the text “You can see the XX Mountains up ahead.” is displayed.

In the present embodiment, the destination suggestion unit 15 may also determine whether or not to suggest a destination, and when it is determined that a destination is suggested, the destination suggestion unit 15 may transmit a control command to suggest a destination to the user terminal device 20. The destination suggestion unit 15 estimates the user's situation and/or the user's surrounding environment, and determines whether or not to suggest a destination based on the user's situation and/or the user's surrounding environment. This makes it possible to suggest a destination at a time that suits the user's convenience and situation.

In particular, in in-car use cases, a driver is more likely to accept a suggestion for a destination if it is a schedule change within a range acceptable to the driver. Further, in the present embodiment, a destination may also be suggested to a passenger, particularly a child. In this case, the driver has the final decision-making power, and therefore, even if the passenger wishes to go to the suggested destination, the driver may refuse the suggestion if it is inconvenient for the driver. In the present embodiment, a suggestion that is inconvenient for the driver is prevented from being suggested to the passenger, and thus, dissatisfaction caused to the passenger not being able to go to a destination that the passenger wishes to go to can be avoided in advance.

The destination suggestion unit 15 determines whether or not to suggest a destination based on at least one of the travel time required to pass through the target POI, the travel costs, and the stay time at the target POI. The travel costs include additional expressway tolls, facility entrance fees, gasoline costs, and the like. The destination suggestion unit 15 acquires a budget and/or time acceptable to the user, which are input by the user, and determines to suggest the target POI as a destination if it is possible to pass through the target POI within the range of the acquired budget and/or time. This makes it possible to prevent unexpected expenses and time from being incurred by passing through a POI.

Further, the destination suggestion unit 15 acquires the behavior history of the user, and determines whether or not to suggest the target POI as a destination based on the behavior history of the user. For example, when the user does not have a visit history of visiting the target POI, the destination suggestion unit 15 determines to suggest the target POI as a destination. This makes it possible to suggest a POI that the user has not visited.

Further, when the target POI is a facility with business hours, the destination suggestion unit 15 determines, based on the business hours of the target POI, whether or not the user's stay time is within the business hours of the target POI. When the user's stay time falls within the business hours of the target POI, the destination suggestion unit 15 determines to suggest the target POI as a destination. The destination suggestion unit 15 estimates the arrival time at the target POI based on the current time and the travel time to the target POI. Then, the destination suggestion unit 15 estimates the stay end time based on the arrival time and the stay time, and determines whether or not the stay end time falls within the business hours. The business hours may be acquired via the Internet. The stay time is, for example, an average stay time at the POI. This makes it possible to prevent a situation in which the target POI has already closed or is about to close for business, despite having passed through the target POI.

Further, when the user travels to the final destination after passing through the target POI, the destination suggestion unit 15 determines whether or not the user can travel to the final destination by the desired arrival time. When the user can travel to the final destination by the desired arrival time, the destination suggestion unit 15 determines to suggest the target POI as a destination. For example, the destination suggestion unit 15 determines whether or not the user can travel to the final destination by the desired arrival time based on the user's desired arrival time at the final destination, the travel time when the user passes through the target POI, and the stay time at the target POI. The final destination is, for example, the user's home.

The destination suggestion unit 15 may acquire traffic information to the target POI and calculate the travel time to the target POI. The destination suggestion unit 15 acquires the user's desired arrival time at the final destination, which is input by the user. The desired arrival time may be an arrival time that is acceptable to the user. Specifically, the user inputs, to the input unit 22 of the user terminal device 20, a latest arrival time that is acceptable as the time for arriving at the final destination. The destination suggestion unit 15 suggests a destination to the user from among only POIs that can be passed through without exceeding the latest arrival time. This allows the user to arrive home at a time that does not interfere with the user's next appointment (work or school) even when the user passes through the target POI.

The destination suggestion unit 15 determines, based on the travel route, whether or not to suggest the target POI as a destination. For example, when the number of waypoints on the travel route is equal to or less than a predetermined number of waypoints, the destination suggestion unit 15 determines to suggest the target POI as a destination. If there are a lot of waypoints set on the travel route, it is considered that the travel has been carefully scheduled in advance. On the other hand, if there are few waypoints set on the travel route, it is considered that there is some leeway in the schedule. In the present embodiment, the target POI can be suggested as a destination if it does not interfere with the schedule of the user.

When there are a plurality of target POIs whose degree of the match is higher than the predetermined threshold, the destination suggestion unit 15 may also suggest the target POI with the highest degree of the match as a destination, or may also suggest the top several target POIs in descending order of the degree of the match as destinations.

Further, when it is determined that a field to which the target POI belongs matches a preferred field of the user, the destination suggestion unit 15 transmits to the user terminal device 20 a control command to display a specialized map specializing in information on the field to which the target POI belongs, instead of the standard map. Specifically, when it is determined that the attribute of the target POI matches the attribute of the user, the destination suggestion unit 15 switches the map to be displayed from the standard map to the specialized map. The destination suggestion unit 15 acquires from the database 2 a specialized map specializing in information on the field indicated by the attribute of the target POI based on the attribute of the target POI, and transmits the acquired specialized map to the user terminal device 20. For example, when the attribute of the target POI is “History”, the destination suggestion unit 15 acquires an old map as a specialized map specializing in information on “History”, and transmits a control command to display the old map. Since the attribute of the target POI matches the attribute of the user, a map specializing in the attribute of the user, that is, information on the preferred field of the user, is displayed. When suggesting a target POI, the destination suggestion unit 15 is not limited to displaying information on the target POI on a specialized map, and may display information on the target POI on a standard map.

Furthermore, when the destination suggestion unit 15 acquires approval for setting the target POI as a destination, which is input by the user, the destination suggestion unit 15 sets the target POI as the destination and causes the user terminal device 20 to start route guidance for the user to travel to the target POI. The destination suggestion unit 15 transmits to the user terminal device 20 a control command to display the travel route to the target POI on a specialized map. Note that the destination suggestion unit 15 may transmit to the user terminal device 20 a control command to switch the map to be displayed from the specialized map to a standard map and display the travel route to the target POI on the standard map.

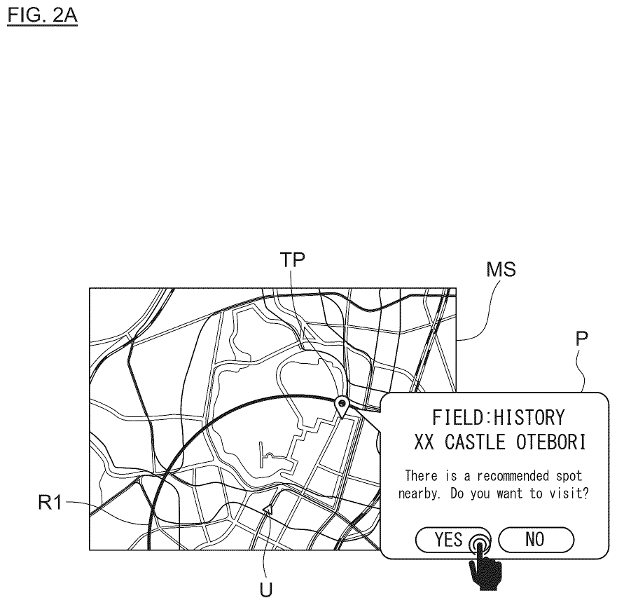

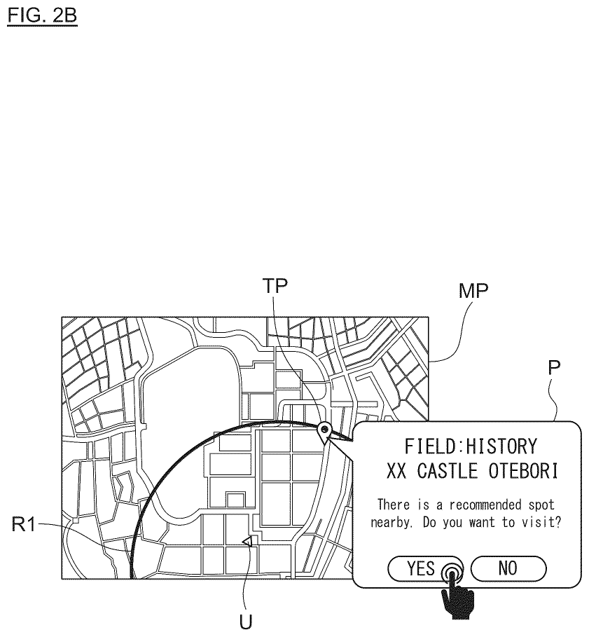

An example of a screen displayed to the user to suggest a target POI as a destination in the present embodiment will now be described with reference to FIG. 2. FIG. 2A is a diagram illustrating an example of a screen on which a target POI is displayed on a standard map in the present invention. In FIG. 2A, the current location of a user U, a first predetermined range R1 with the current location of the user U as a starting point, and a spot TP that is the target POI are displayed on a standard map MS. Further, in FIG. 2A, suggestion information P that suggests the target POI as a destination is displayed. The suggestion information P includes the attribute of the target POI, the name of the target POI, a message indicating that the target POI is suggested as a destination, and icons indicating approval and refusal. In the example of FIG. 2A, “History” as the attribute of the target POI, “XX Castle Otebori” as the name of the target POI, and “There is a recommended spot nearby. Do you want to visit?” as the message are displayed. The icons indicating approval and refusal are displayed as “Yes” and “No” icons. In the present embodiment, the user looks at a screen as illustrated in FIG. 2A and determines whether or not to set the target POI as a destination.

FIG. 2B is a diagram illustrating an example of a screen on which a target POI is displayed on a specialized map in the present invention. In FIG. 2B, the current location of a user U, a first predetermined range R1 with the current location of the user U as a starting point, and a spot TP that is the target POI are displayed on a specialized map MP. In the example of FIG. 2, an old map is displayed as the specialized map. Further, in FIG. 2B, similar to FIG. 2A, suggestion information P that suggests the target POI as a destination is displayed. In the present embodiment, supporting learning of a specific field in conjunction with navigation allows the user to learn not only information on the target POI, but also information on the specific field around the current location of the user.

Note that, in the present embodiment, when the POI determination unit 14 determines that a POI is present within the second predetermined range from the search center point, the destination suggestion unit 15 determines whether or not a field to which the target POI within the second predetermined range belongs matches a preferred field of the user. When it is determined that a field to which the target POI belongs matches a preferred field of the user, the destination suggestion unit 15 may transmit to the user terminal device 20 a control command to display a specialized map instead of the standard map. The destination suggestion unit 15 may also transmit a control command to suggest the target POI as a destination.

Further, in the present embodiment, when the user arrives at the target POI, the destination suggestion unit 15 transmits to the user terminal device 20 a control command to display a specialized map. For example, the destination suggestion unit 15 determines, based on the current location of the user and the location of the target POI, whether or not the user has arrived at the target POI. When it is determined that the user has arrived at the target POI, the destination suggestion unit 15 transmits to the user terminal device 20 a control command to display a specialized map specializing in information on a field to which the target POI belongs. When the destination suggestion unit 15 has provides route guidance to the target POI on a standard map, the destination suggestion unit 15 may display the specialized map instead of the standard map when the user arrives at the target POI, and when the destination suggestion unit 15 has provided route guidance to the target POI on a specialized map, the destination suggestion unit 15 may continue to display the specialized map even after the user arrives at the target POI.

The communication unit 16 is a communication interface that supports various communication standards. The communication unit 16 supports, for example, a wired LAN standard, a wireless LAN standard, and the like. The communication unit 16 transmits and receives information to and from the user terminal device 20 via the communication network 40.

The user terminal device 20 is a portable information communication terminal. Examples of the user terminal device 20 include a smartphone, a laptop computer, a tablet terminal, and a head-mounted display. Further, when the user is traveling by vehicle, the user terminal device 20 may be a rear seat monitor installed in the vehicle. As illustrated in FIG. 1, the user terminal device 20 includes the GPS receiving unit 21, the input unit 22, a control unit 23, an output unit 24, and a communication unit 25.

The GPS receiving unit 21 acquires location information of the user terminal device 20 from GPS satellites. An example of the location information of the user terminal device 20 is information on latitude and longitude. The GPS receiving unit 21 acquires location information of the user terminal device 20 from GPS satellites at predetermined intervals. Since the user carries the user terminal device 20 while traveling, the location information of the user terminal device 20 changes as the user travels.

The input unit 22 is an input interface that receives input from the user. The input unit 22 is composed of one or more devices. For example, the input unit 22 is composed of a touch panel or a keyboard through which the user can input characters, and a microphone through which the user can input voice. Information to be input by the user to the input unit 22 is, for example, the destination of the user.

Further, information to be input by the user to the input unit 22 is the attribute of the user, that is, a preferred field of the user. In the present embodiment, for example, before route guidance is started, a questionnaire on a five-level scale for a field in which the user is interested is displayed through the output unit 24, and the input unit 22 acquires a preferred field of the user as a user's response to the questionnaire. Before using the information provision system 100, the user inputs a preferred field of the user to the input unit 22 in advance. The information input by the user is transmitted to the information provision device 1 through the communication unit 25.

Further, information to be input by the user to the input unit 22 is an approval operation or a refusal operation for setting the target POI as a destination. In the present embodiment, spot information of the target POI and suggestion information that suggests setting the target POI as a destination are displayed through the output unit 24. The user inputs, through the input unit 22, an approval operation or a refusal operation for setting the target POI as a destination. Further, information to be input by the user to the input unit 22 is a search center point that is the center of the search range. Further, in the present embodiment, when a standard map or a specialized map is displayed through the output unit 24, the user selects a search center point on the standard map or the specialized map.

The control unit 23 is a computer including a ROM in which programs for executing various processes are stored, a CPU that executes the programs stored in the ROM, and a RAM that functions as an accessible storage device. The control unit 23 provides travel route guidance to the user. The control unit 23 receives location information of a user terminal device 20 from a GPS receiving unit 21 at predetermined intervals. Since the location information of the user terminal device 20 changes as the user terminal device 20 travels, the control unit 23 provides route guidance along a travel route according to the current location of the user terminal device 20.

For example, when the control unit 23 acquires a control command to display a standard map or a specialized map from the information provision device 1 through the communication unit 25, the control unit 23 displays the standard map or the specialized map to the user through the output unit 24. Then, when the control unit 23 acquires a control command to display a travel route on a standard map or a specialized map from the information provision device 1, the control unit 23 displays the travel route on the standard map or the specialized map through the output unit 24. The control unit 23 displays the travel route to the user through the output unit 24 and provides route guidance. The control unit 23 can provide to the user guidance on the travel route using a route guidance method known at the time of filing of this application. A specific route guidance method will be omitted.

Further, when the attribute of the user is input to the input unit 22, the control unit 23 transmits the attribute of user to the information provision device 1 through the communication unit 25. Further, when a destination is input to the input unit 22, the control unit 23 transmits the current location of the user at that time and the destination to the information provision device 1. Further, the control unit 23 suggests setting the target POI as a destination through the output unit 24. For example, the control unit 23 displays to the user through the output unit 24 spot information of the target POI as well as suggestion information that suggests setting the target POI as a destination. Further, when an approval operation for setting the target POI as a destination is input to the input unit 22, the control unit 23 transmits approval for setting the target POI as a destination to the information provision device 1 through the communication unit 25.

The output unit 24 is an output interface that outputs route guidance based on the generated travel route. In the present embodiment, the output unit 24 displays to the user a map, a travel route of the user, a target POI, and suggestion information that suggests the target POI as a destination. Further, the output unit 24 notifies the user of detailed information on the target POI. The output unit 24 is composed of one or more devices. For example, the output unit 24 is composed of a display that displays route guidance on a screen, and a speaker that outputs audio data of the route guidance. Examples of the display include a liquid crystal panel and an organic EL panel.

For example, the output unit 24 displays a standard map to the user, and displays a travel route to the destination superimposed on the standard map. Further, when the output unit 24 receives a control command to display a specialized map from the information provision device 1, the output unit 24 displays the specialized map and displays a travel route to the target POI superimposed on the specialized map. As described above, the travel route to the target POI is generated based on the standard map. In other words, the travel route to the target POI is a route along roads on the standard map. The locations of roads on a standard map and a specialized map may not match, for example, in a case where the specialized map is an old map. Therefore, when a travel route generated based on a standard map is displayed superimposed on a specialized map, for example, the travel route may be displayed in a place where there is no road on the specialized map. Specifically, the output unit 24 switches the map to be displayed from the standard map to the specialized map.

In the present embodiment, before starting route guidance, the output unit 24 displays a question for acquiring the attribute of the user. For example, the output unit 24 displays to the user a questionnaire on a five-level scale for the degree to which the user prefers a specific field.

The communication unit 25 is a communication interface that supports various communication standards. The communication unit 25 supports, for example, a wired LAN standard, a wireless LAN standard, and the like. The communication unit 25 transmits and receives information to and from the information provision device 1 via the communication network 40.

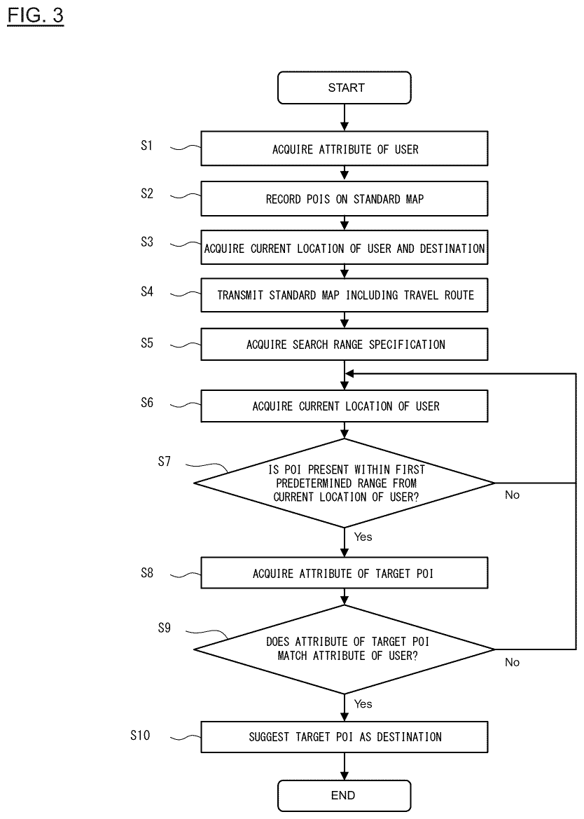

Next, a control procedure of the information provision method executed by the information provision device 1 will be described with reference to FIG. 3. FIG. 3 is a flowchart illustrating an example of a control procedure for executing the information provision method. In step S1, the processor 10 acquires the attribute of the user. The processor 10 acquires the attribute of the user from the user terminal device 20 through the communication unit 16. An example of the attribute of the user is a preferred field of the user. In step S2, the processor 10 records information on POIs to which attributes have been assigned on a standard map. For example, the processor 10 acquires a standard map and POI information from an external database, and records the POI information on the standard map.

In step S3, the processor 10 acquires the current location of the user and a destination from the user terminal device 20. In step S4, the processor 10 transmits to the user terminal device 20 the standard map including a travel route. The processor 10 generates a travel route from the current location of the user acquired in step S3 to the destination, and transmits to the user terminal device 20 a control command to display the travel route on the standard map. In step S5, the processor 10 acquires search range specification from the user terminal device 20. The search range specification includes a search range desired by the user. In the present embodiment, the search range will be described as a first predetermined range with the current location of the user as a starting point. After the user starts traveling, the processor 10 proceeds to step S6.

In step S6, the processor 10 acquires the current location of the user. The processor 10 acquires the location of the user terminal device 20 from the user terminal device 20 as the current location of the user. In step S7, the processor 10 determines whether or not a POI is present within the first predetermined range from the current location of the user. If it is determined that a POI is present within the first predetermined range from the current location of the user, the processor 10 proceeds to step S8. If it is determined that no POI is present within the first predetermined range from the current location of the user, the processor 10 returns to step S6 to repeat the subsequent flow. In step S8, the processor 10 acquires the attribute of a target POI within the first predetermined range. The processor 10 acquires the attributes of the POIs from the standard map on which information on the POIs are recorded. The attribute of a POI is a field to which the POI belongs.

In step S9, the processor 10 determines whether or not the attribute of the target POI matches the attribute of the user. If it is determined that the attribute of the target POI matches the attribute of the user, the processor 10 proceeds to step S10. If it is determined that the attribute of the target POI does not match the attribute of the user, the processor 10 returns to step S6 to repeat the subsequent flow. In step S10, the processor 10 suggests to the user the target POI whose attribute matches the attribute of the user as a destination. The processor 10 transmits to the user terminal device 20 a control command to suggest the target POI as a destination.

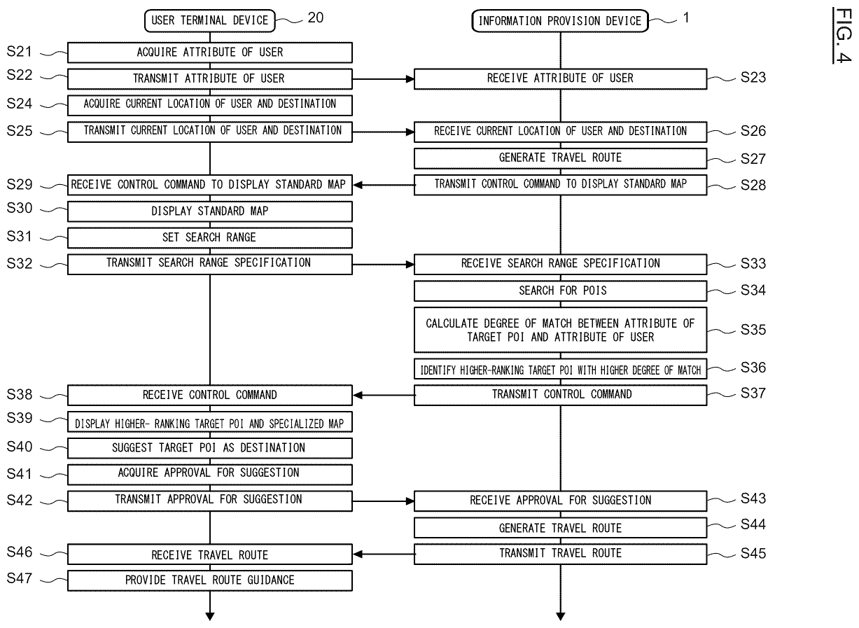

Next, an operation of each of the devices constituting the information provision system 100 will be described with reference to FIG. 4. FIG. 4 is a time chart before the start of route guidance to a target POI in the information provision system 100.

In step S21, the user terminal device 20 acquires the attribute of the user. In step S22, the user terminal device 20 transmits the attribute of the user to the information provision device 1. In step S23, the information provision device 1 receives the attribute of the user from the user terminal device 20. In step S24, the user terminal device 20 acquires the current location of the user and a destination. When the user inputs a destination, the user terminal device 20 acquires the current location of the user at that time and the input destination. In step S25, the user terminal device 20 transmits the current location of the user and the destination to the information provision device 1. In step S26, the information provision device 1 receives the current location of the user and the destination from the user terminal device 20. In step S27, the information provision device 1 generates a travel route from the current location of the user to the destination. In step S28, the information provision device 1 transmits to the user terminal device 20 a control command to display a standard map. For example, the information provision device 1 transmits a control command to display a standard map including the travel route generated in step S27.

In step S29, the user terminal device 20 receives from the information provision device 1 the control command to display a standard map. In step S30, the user terminal device 20 displays the standard map including the travel route to the user. In step S31, the user terminal device 20 acquires a search range desired by the user. For example, when the user sets the current location of the user as a search center point, a first predetermined range from the current location of the user is set as the search range. In step S32, the user terminal device 20 transmits to the information provision device 1 search range specification including the search range set by the user in step S31. In step S33, the information provision device 1 receives the search range specification from the user terminal device 20. In step S34, the information provision device 1 searches for POIs within the first predetermined range from the current location of the user based on the search range specification. If a POI is present within the first predetermined range, the information provision device 1 proceeds to step S35.

In step S35, the information provision device 1 calculates the degree of a match between each of the attributes of target POIs within the first predetermined range and the attribute of the user. In step S36, the information provision device 1 identifies a higher-ranking target POI with a higher degree of the match. In step S37, the information provision device 1 transmits to the user terminal device 20 a control command to display a specialized map including spot information of the higher-ranking target POI. At this time, the information provision device 1 transmits to the user terminal device 20 a control command to suggest the target POI as a destination. In step S38, the user terminal device 20 receives from the information provision device 1 the control command to display a specialized map and the control command to suggest the target POI as a destination. In step S39, the user terminal device 20 displays the specialized map including the spot information of the higher-ranking target POI to the user. In step S40, the user terminal device 20 suggests the target POI as a destination.

In step S41, the user terminal device 20 acquires approval for the suggestion of setting the target POI as a destination. In step S42, the user terminal device 20 transmits to the information provision device 1 approval for the suggestion of setting the target POI as a destination. In step S43, the information provision device 1 receives from the user terminal device 20 approval for the suggestion of setting the target POI as a destination. In step S44, the information provision device 1 generates a travel route to the target POI. In step S45, the information provision device 1 transmits the travel route to the user terminal device 20. In step S46, the user terminal device 20 receives the travel route from the information provision device 1. In step S47, the user terminal device 20 displays the travel route on the specialized map and starts route guidance to the user.

As described above, in the present embodiment, the information provision method is performed by a processor configured to provide information to a user. The processor acquires an attribute of the user; acquires a current location of the user after the user has started traveling; when a POI is present within a first predetermined range from the current location of the user on a standard map including POIs to which attributes have been assigned, determines whether or not an attribute of a target POI within the first predetermined range matches the attribute of the user; and when it is determined that the attribute of the target POI matches the attribute of the user, transmits a control command to suggest the target POI as a destination. This makes it possible to suggest a spot suitable for the user according to the actual location of the user during traveling after the user has started traveling.

Further, in the present embodiment, the processor acquires a preferred field of the user as the attribute of the user; before the user starts traveling, transmits to a terminal device of the user a control command to display the standard map; and when it is determined that a field to which the target POI belongs matches the preferred field of the user, transmits to the terminal device a control command to display a specialized map specializing in information on the field to which the target POI belongs, instead of the standard map. This allows the user to know information related to the attribute of the POI around the user.

Further, in the present embodiment, the processor transmits to the terminal device a control command to display a travel route from the current location of the user to the target POI on the specialized map. This allows the user to check the travel route while viewing the specialized map.

Further, in the present embodiment, the processor transmits to a terminal device of the user a control command to suggest changing the destination to the target POI, or a control command to suggest setting the target POI as a waypoint between the current location of the user and the destination. This allows the user to confirm whether to set a POI around the user as a destination or a waypoint.

Further, in the present embodiment, the attribute is an academic-related field or a hobby-related field. This makes it possible to present a POI that belongs to the academic- or hobby-related field as a destination.

Further, in the present embodiment, the academic-related filed includes at least any one of history-, geography-, geology-, meteorology-, and paleontology-related fields. This makes it possible to present a POI that belongs to history-, geography-, geology-, meteorology-, and paleontology-related fields as a destination.

Further, in the present embodiment, the processor acquires a preferred field of the user as the attribute of the user; before the user starts traveling, transmits to a terminal device of the user a control command to display a standard map; when the user sets a search center point on the standard map, determines whether or not the POI is present within a second predetermined range from the search center point; when it is determined that the POI is present within the second predetermined range from the search center point, determines whether or not a field to which a target POI within the second predetermined range belongs matches the preferred field of the user; and when it is determined that the field to which the target POI belongs matches the preferred field of the user, transmits to the terminal device a control command to display a specialized map specializing in information on the field to which the target POI belongs, instead of the standard map. This allows the user to know information on the field to which the POI around a point selected by the user belongs.

Further, in the present embodiment, the processor determines whether or not the user has arrived at the target POI; and when it is determined that the user has arrived at the target POI, transmits to a terminal device of the user a control command to display a specialized map specializing in information on a field to which the target POI belongs. This allows the user to know information on a specific field while viewing a map after arriving at the target POI.

### Second Embodiment

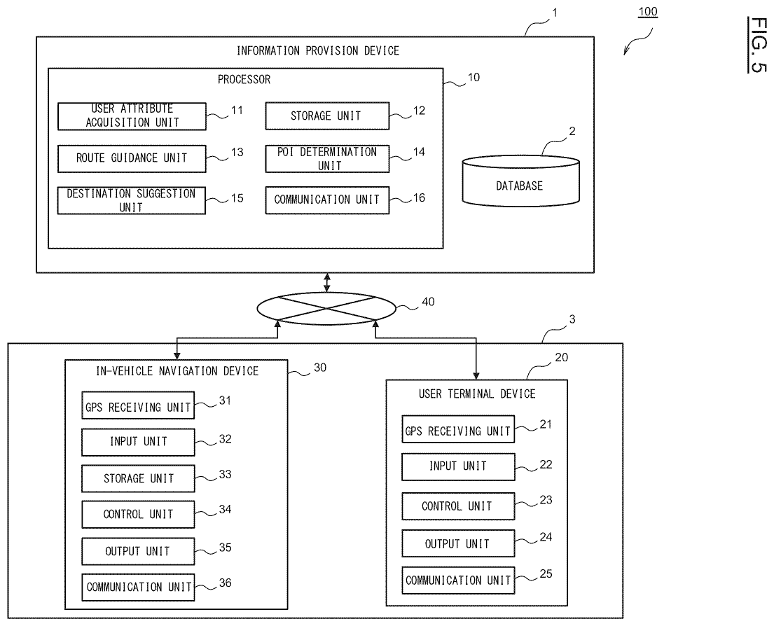

Next, a second embodiment of the present invention will be described with reference to FIG. 5. FIG. 5 is a block diagram of an information provision system according to a second embodiment of the present invention. The information provision system according to the second embodiment has the same configuration as the first embodiment and operates in the same manner as the first embodiment, except for the differences from the information provision system according to the first embodiment in the points described below, and the description of the first embodiment will be used as appropriate. In the present embodiment, the information provision system 100 includes an in-vehicle navigation device 30 in addition to the user terminal device 20, and the information provision device 1, the user terminal device 20, and the in-vehicle navigation device 30 are configured to be able to exchange information with each other via the communication network 40. The user is a passenger in a vehicle 3 and sits in the passenger seat or a rear seat of the vehicle 3. The in-vehicle navigation device 30 is a device mounted in the vehicle 3 and provides information to a driver. In the present embodiment, the information provision device 1 generates a traveling route, but is not limited to this, and the in-vehicle navigation device 30 may generate a traveling route.

In the present embodiment, before the vehicle in which the user is starts traveling, when route guidance is started, the route guidance unit 13 transmits a control command to display a standard map to both the user terminal device 20 and the in-vehicle navigation device 30. Further, when the route guidance unit 13 generates a traveling route from the current location of the vehicle 3 to the destination of the vehicle 3, the route guidance unit 13 transmits to both the user terminal device 20 and the in-vehicle navigation device 30 a control command to display the traveling route superimposed on the standard map.

When the POI determination unit 14 determines that a field to which the target POI belongs matches a preferred field of the user, the destination suggestion unit 15 transmits to both the user terminal device 20 and the in-vehicle navigation device 30 a control command to display a specialized map specializing in information on a field to which the target POI belongs, instead of the standard map.

When the destination suggestion unit 15 acquires from the user terminal device 20 approval for setting the target POI as a destination, the destination suggestion unit 15 may also transmit to the in-vehicle navigation device 30 a control command to display the target POI and/or the traveling route to the target POI on the standard map. In other words, in the present embodiment, if the passenger gives approval, information on the target POI approved by the passenger is displayed on the in-vehicle navigation device 30 of the driver. As described above, in the present embodiment, the driver and the passenger can share the same traveling route while viewing different displays.

The in-vehicle navigation device 30 provides route guidance along the traveling route to the driver. The in-vehicle navigation device 30 includes a GPS receiving unit 31, an input unit 32, a storage unit 33, a control unit 34, an output unit 35, and a communication unit 36.

The GPS receiving unit 31 acquires location information of the vehicle 3 from GPS satellites. An example of the location information of the vehicle 3 is information on latitude and longitude. The GPS receiving unit 31 acquires the location information of the vehicle 3 from GPS satellites at predetermined intervals, and therefore, the location information of the vehicle 3 changes as the vehicle 3 travels. The predetermined interval is a period that is determined in advance.

The input unit 32 is an input interface that receives input from the passenger. The input unit 32 is composed of one or more devices. For example, the input unit 32 is composed of a touch panel through which the passenger can input characters, and a microphone through which the passenger can input voice. In a case where the input unit 32 is a touch panel, the input unit 32 may be configured integrally with the output unit 35. Input information to be input by the passenger to the input unit 32 includes, for example, a destination of the vehicle 3. Further, when suggestion information to set a destination is displayed to the user, the input information includes, for example, an approval operation or a refusal operation for setting the destination.

The storage unit 33 stores various maps. In the present embodiment, the storage unit 33 stores standard maps and specialized maps. Note that, in the present embodiment, a configuration in which the storage unit 33 stores the maps is described as an example, but the location where the maps are stored is not limited to the storage unit 33, and the maps may be stored outside the vehicle 3. For example, a server provided outside the vehicle 3 may store the maps, and the communication unit 36 may be configured to download the maps from the server.

The control unit 34 is a computer including a ROM in which programs for executing various processes are stored, a CPU that executes the programs stored in the ROM, and a RAM that functions as an accessible storage device. The control unit 34 provides guidance on a traveling route of the vehicle 3 to the driver of the vehicle 3. When the control unit 34 acquires a traveling route from the information provision device 1, the control unit 34 displays the traveling route to the driver through the output unit 35. In the present embodiment, the control unit 34 is not limited to acquiring a traveling route from the information provision device 1, and may also generate a traveling route based on a destination input by the driver.

The control unit 34 receives location information of the vehicle 3 from the GPS receiving unit 31 at predetermined intervals. Since the location information of the vehicle 3 changes as the vehicle 3 travels, the control unit 34 provides route guidance along the traveling route according to the current location of the vehicle 3. The control unit 34 can provide to the user guidance on the traveling route of the vehicle 3 using a route guidance method known at the time of filing of this application. A specific route guidance method will be omitted.

Further, when the control unit 34 receives from the information provision device 1 a control command to suggest the target POI as a destination, the control unit 34 suggests setting the target POI as a destination to the driver through the output unit 35. For example, the control unit 34 displays the location of the target POI and/or the traveling route from the current location of the vehicle 3 to the target POI on a standard map or a specialized map, and displays suggestion information that suggests setting the target POI as a destination.

When the control unit 34 acquires approval for setting the target POI as a destination, which is input by the driver, the control unit 34 sets the target POI as a destination. For example, the control unit 34 updates the initially set destination to the target POI, and generates a traveling route from the current location of the vehicle 3 to the location of the target POI. Further, when the control unit 34 sets the location of the target POI as a waypoint, the control unit 34 generates a traveling route from the current location of the vehicle 3 to the initially set destination via the target POI.

The output unit 35 is an output interface that outputs route guidance provided by the control unit 34. Further, in the present embodiment, the output unit 35 outputs a map, a travel route of the user, a target POI, and suggestion information that suggests the target POI as a destination. The output unit 35 is composed of one or more devices. For example, the output unit 35 is composed of a display that displays route guidance on a screen, and a speaker that outputs audio data of the route guidance. Examples of the display include a liquid crystal panel and an organic EL panel.

For example, the output unit 35 displays a standard map, and displays a traveling route and the current location of the vehicle 3 on the standard map. Further, the output unit 35 displays the target POI transmitted from the information provision device 1 on the standard map. The output unit 35 may also display a traveling route from the current location of the vehicle 3 to the target POI on the standard map.

Further, when the output unit 35 receives from the information provision device 1 a control command to display a specialized map specializing in information on a field to which the target POI belongs, the output unit 35 displays the specialized map instead of the standard map. In other words, the output unit 35 switches the map to be displayed from the standard map to the specialized map. The output unit 35 may display a traveling route to the target POI on the specialized map.

The communication unit 36 is a device having a wireless communication function for wirelessly transmitting and receiving information to and from the outside. Examples of the communication unit 36 include a telematics control unit. The communication unit 36 transmits and receives information to and from the information provision device 1 and the user terminal device 20 via the communication network 40 by using the wireless communication function.

As described above, in the present embodiment, the processor acquires a preferred field of the user as the attribute of the user; before a vehicle in which the user is starts traveling, transmits to an in-vehicle navigation device of the vehicle a control command to display the standard map; and when it is determined that a field to which the target POI belongs matches the preferred field of the user, transmits to the in-vehicle navigation device a control command to display a specialized map specializing in information on the field to which the target POI belongs, instead of the standard map. This makes it possible to switch the map displayed to the driver from the standard map to the specialized map.

Note that the embodiments described above are described to facilitate understanding of the present invention, and are not described to limit the present invention. Therefore, the elements disclosed in the above-described embodiments are meant to include all design changes and equivalents that fall within the technical scope of the present invention.

### DESCRIPTION OF REFERENCE NUMERALS

100 Information provision system
1 Information provision device
10 Processor
11 User attribute acquisition unit
12 Storage unit
13 Route guidance unit
14 POI determination unit
15 Destination suggestion unit
16 Communication unit
2 Database
20 User terminal device

1. An information provision method performed by a processor configured to provide information to a user, the information provision method comprising, by the processor:
acquiring an attribute score of the user indicating a degree to which the user prefers a preferred field of the user;
acquiring a current location of the user after the user has started traveling;
when a POI is present within a first predetermined range from the current location of the user on a standard map on which information on POIs are recorded including a field to which the POIs belong, calculating a degree of a match between a field to which a target POI belongs within the first predetermined range and the preferred field of the user;
when the degree of the match is higher than a predetermined threshold, determining that the field to which the target POI belongs matches the preferred field of the user; and
when determining that the field to which the target POI belongs matches the preferred field of the user, transmitting a control command to suggest the target POI as a destination,
wherein the degree of the match is calculated to be higher as the attribute score of the user and an attribute score of the target POI are higher, the attribute score of the target POI indicating a degree to which the target POI is recommended to users who prefer the field to which the target POI belongs.

2. The information provision method according to claim 1, comprising, by the processor:
before the user starts traveling, transmitting to a terminal device of the user a control command to display the standard map; and
when determining that the field to which the target POI belongs matches the preferred field of the user, transmitting to the terminal device a control command to display a specialized map specializing in information on the field to which the target POI belongs, instead of the standard map.

3. The information provision method according to claim 2, further comprising:
transmitting to the terminal device a control command to display a travel route from the current location of the user to the target POI on the specialized map by the processor.

4. The information provision method according to claim 1, further comprising:
transmitting to a terminal device of the user a control command to suggest changing the destination to the target POI, or a control command to suggest setting the target POI as a waypoint between the current location of the user and the destination by the processor.

5. The information provision method according to claim 1, comprising, by the processor:
before a vehicle in which the user is starts traveling, transmitting to an in-vehicle navigation device of the vehicle a control command to display the standard map; and
when determining that the field to which the target POI belongs matches the preferred field of the user, transmitting to the in-vehicle navigation device a control command to display a specialized map specializing in information on the field to which the target POI belongs, instead of the standard map.

6. (canceled)

7. The information provision method according to claim 1, wherein the field includes history-, geography-, geology-, meteorology-, and paleontology-related fields.

8. The information provision method according to claim 1, comprising, by the processor:
before the user starts traveling, transmitting to a terminal device of the user a control command to display the standard map;
when the user sets a search center point on the standard map, determining whether or not the POI is present within a second predetermined range from the search center point;
when determining that the POI is present within the second predetermined range from the search center point, determining whether or not the field to which a target POI within the second predetermined range belongs matches the preferred field of the user; and
when determining that the field to which the target POI belongs matches the preferred field of the user, transmitting to the terminal device a control command to display a specialized map specializing in information on the field to which the target POI belongs, instead of the standard map.

9. The information provision method according to claim 1, comprising, by the processor:
determining whether or not the user has arrived at the target POI; and
when determining that the user has arrived at the target POI, transmitting to a terminal device of the user a control command to display a specialized map specializing in information on the field to which the target POI belongs.

10. An information provision device comprising a processor configured to provide information to a user, wherein the processor is configured to:
acquire an attribute score of the user indicating a degree to which the user prefers a preferred field of the user;
acquire a current location of the user after the user has started traveling;
when a POI is present within a first predetermined range from the current location of the user on a standard map on which information on POIs are recorded including a field to which the POIs belong, calculating a degree of a match between a field to which a target POI belongs within the first predetermined range and the preferred field of the user;
when the degree of the match is higher than a predetermined threshold, determine that the field to which the target POI belongs matches the field of the user; and
when determining that the field to which the target POI belongs matches the preferred field of the user, transmit a control command to suggest the target POI as a destination,
wherein the degree of the match is calculated to be higher as the attribute score of the user and an attribute score of the target POI are higher, the attribute score of the target POI indicating a degree to which the target POI is recommended to users who prefer the field to which the target POI belongs.
